(19) United States
(12) Patent Application Publication
(10) Pub. No.: US 2008/0286040 A1
(43) Pub. Date: Nov. 20, 2008

(54) Device for Connecting an Intermediate Shaft to a Pinion of a Steering Mechanism

(75) Inventors: Marian Piskon, Wiesbaden (DE); Norbert Ranker, Russelsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 11/996,055

(22) PCT Filed: Jul. 6, 2006
(86) PCT No.: PCT/EP2006/006583

§ 371 Date: Jul. 28, 2008

(30) Foreign Application Priority Data
Jul. 19, 2005 (DE) 10 2005 033 627.2

(51) Int. Cl. F16B 7/04

(52) U.S. Cl. 403/373

(57) ABSTRACT

The invention relates to a clamping piece which is used to connect an intermediate shaft to a pinion shaft of a steering mechanism of a motor vehicle. The clamping piece comprises two lateral elements which are embodied in such a manner that the pinion shaft can be received therebetween by clamping by means of a clamping screw. The clamping screw also comprises a pressure element which comprises a protruding pressure section and which is mounted in a displaceable manner on the clamping screw counter to the friction force.

### CROSS-REFERENCE TO RELATED APPLICATIONS

This application is a U.S. National-Stage entry under 35 U.S.C. § 371 based on International Application No. PCT/EP2006/006583, filed Jul. 6, 2006, which was published under PCT Article 21(2) and which claims priority to German Application No. DE 10 2005 033 627.2, filed Jul. 19, 2005.

### TECHNICAL FIELD

The present invention relates to a clamping part for connecting an intermediate shaft to a pinion shaft of a steering gear of a motor vehicle.

Clamping parts are also referred to as coupling parts, using which a steering column is connected to a shaft pin of such a steering gear. A clamping part is known from DE 40 06 787 C1. The clamping part disclosed therein is very complex to produce, although advantages in assembly are supposed to be achieved therewith in relation to the previously known clamping parts. Because of the complex construction, which provides at least one complicated milled part and a coiled spring, it has not proven itself in practice. However, in steering gears which are to be disconnected from the steering column of a motor vehicle more often, for example, in Formula 1 vehicles, complexity of this type is worth it.

It is thus the object of the present invention to specify an improved clamping part, a steering unit, and a method for mounting such a steering unit.

### SUMMARY

The present invention provides a clamping part and/or a coupling parts for connecting an intermediate shaft and/or a steering column to a pinion shaft and/or to a shaft pin of a steering gear of a motor vehicle. The clamping part has two side jaws, which are implemented in such a way that the pinion shaft is receivable between them with clamping of the side jaws using a clamping bolt. The clamping bolt has an actuating element on one end for an actuating tool. The actuating tool may be a wrench, the actuating element being implemented as a bolt head or a similar feature.

On the end opposite to the actuating element, the clamping bolt has a threaded section, which engages in a corresponding threaded section on one of the two side jaws in the clamping part.

According to a basic idea of the present invention, the clamping bolt is provided with a pressure element, which has a projecting pressure section. The pressure element is mounted so it is movable on the clamping bolt against a friction force.

Using such a clamping part, simple and permanent connections may be produced between intermediate shaft and pinion shaft. The pressure element ensures that the particular impinged shaft, i.e., the intermediate shaft or the pinion shaft, is pressed solidly in the area between the two side jaws of the clamping part, this occurring upon tightening of the clamping bolt without further action. Upon tightening of the clamping bolt, the pressure element rotates with the clamping bolt until it contacts the exterior side of the corresponding shaft. When the clamping bolt is rotated further starting from this state, this occurs against a friction force which is generated between the pressure element and the clamping bolt. This friction force acts as a pressure force on the loaded shaft. The desired impingement of the affected shaft is thus caused.

In a particularly advantageous embodiment, the pressure element is mounted so it is rotatable on a ring shoulder of the clamping bolt. However, it is also conceivable to mount the pressure element so it is displaceable on the clamping bolt. The rotatable mounting particularly favors a simple actuation of the pressure element when the clamping bolt is tightened.

It may be particularly advantageous to implement the pressure element as a gripper spring element, which encloses a central ring shoulder of the clamping bolt. The central ring shoulder is provided between the bolt head and the threaded section of the clamping bolt. Using a clamping part thus equipped, boundary conditions in the assembly may be reacted to especially well by suitable selection of the dimensions of ring shoulder and gripper spring element. Thus, for example, by pressing together the gripper spring element using simple pliers, a higher friction force may be produced upon rotation on the ring shoulder when this is required. For this purpose, leaving a spring slot open on the circumference of the gripper spring element has proven itself, the width of the spring slot influencing the pre-tension force.

The present invention also comprises a steering gear having a clamping part according to the present invention and a motor vehicle having such a steering gear according to the present invention.

### BRIEF DESCRIPTION OF THE DRAWINGS

The present invention will hereinafter be described in conjunction with the following drawing figures, wherein like numerals denote like elements, and

FIG. 1 shows a perspective view of a clamping part according to the present invention having an inserted pinion shaft;

FIG. 2 shows a clamping bolt for the clamping part from FIG. 1 in partial section;

FIG. 3 shows a cross-section through the clamping part from FIG. 1 having an inserted clamping bolt from FIG. 2; and

FIG. 4 shows a further cross-section through the clamping part from FIG. 3, some details being left out for a better overview.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

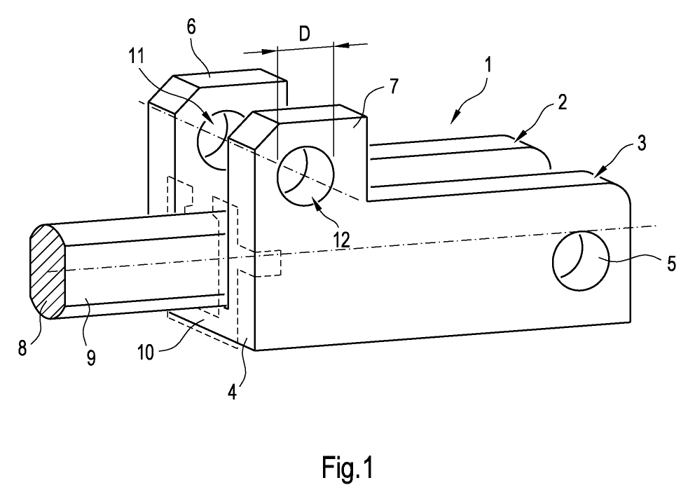

FIG. 1 shows a perspective view of a clamping part 1. The clamping part 1 is composed of a left side jaw 2, a right side jaw 3, and a floor plate 4 connecting them. An intermediate shaft pin opening 5 is provided in each case in the left side jaw 2 and in the right side jaw 3, only that in the right side jaw 3 being visible in this view. An intermediate shaft (not shown) is connected to the clamping part 1 by an intermediate shaft pin (also not shown in this view), in that this pin is inserted into the two intermediate shaft pin openings 5 and also into an opening provided in the intermediate shaft. A left clamping bolt eye 6 extends upward from the left side jaw 2. A right clamping bolt eye 7 also extends upward from the right side jaw.

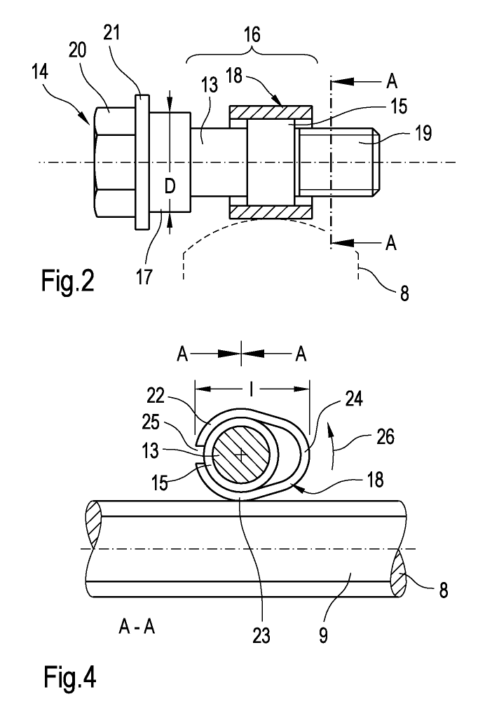

A left receptacle opening 11 having an internal thread is provided in the left clamping bolt eye 6. A right receptacle opening 12 corresponding thereto is provided in the right clamping bolt eye 7, which is implemented as cylindrically smooth on its interior side. The left receptacle opening 11 and the right receptacle opening 12 align with one another, so that a clamping bolt 14 is insertable, which is shown in greater detail in FIG. 2.

A pinion shaft 8, which is provided with flattened areas 9 on both sides, is received between the left clamping bolt eye 6 and the right clamping bolt eye 7. Only one of the two flattened areas 9 is visible in FIG. 1. The distance of the two flattened areas 9 to one another is selected in such a way that the pinion shaft 8 may be inserted easily into the area between the left clamping bolt eye 6 and the right clamping bolt eye 7.

After the pinion shaft 8 is inserted into the clamping part 1, a securing plate 10 (shown only by dashed lines in FIG. 1) holds the pinion shaft solidly at the position shown in FIG. 1, at which the line of symmetry of the pinion shaft 8 aligns with the line of symmetry of the intermediate shaft pin opening 5.

The clamping bolt 14, which is shown in cross-section in FIG. 2, is composed of a bolt head 20 provided as an actuating section, an adjoining disk shoulder 21, and a right bearing section 17 adjoining the disk shoulder 21, which is intended to be received in the right receptacle opening 12 in the right side jaw 3. The diameter of the right bearing section 17 is selected in such a way that a clearance fit results in the right receptacle opening 12, which allows rotation of the clamping bolt 14 when it is inserted into the right clamping bolt eye 7.

In the clamping bolt 14, a pressure section 16 adjoins the right bearing section 17, which is composed of a support pin 13 and a ring shoulder 15 protruding from the support pin 13. A gripper spring element 18 is situated on the ring shoulder 15. The gripper spring element 18 and/or its exterior shape may be seen particularly well in FIG. 4.

Finally, an external threaded section 19 adjoins the ring shoulder 15, which is intended to be received in the left receptacle opening 11.

In an improved clamping bolt (not shown here), the ring shoulder 15 extends up to the right bearing section 17. Instead of a shoulder, a bevel is provided on the other side of the ring shoulder 15 as an inclined transition between ring shoulder 15 and external threaded section 19. This makes it easier to push the gripper spring element 18 onto the ring shoulder.

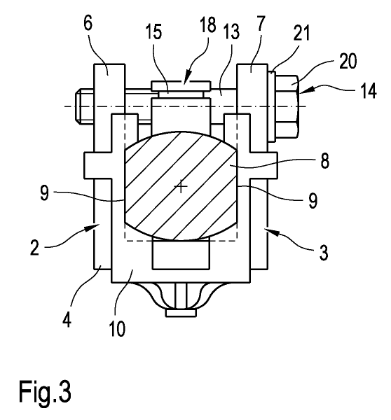

FIG. 3 shows the clamping part 1 from FIG. 1 having a clamping bolt 14 according to FIG. 2 inserted therein. As may be seen especially well in this view, the gripper spring element 18 presses against the pinion shaft 8. The left clamping bolt eye 6 and the right clamping bolt eye 7 are, because of the effect of the clamping bolt 14, drawn against one another and clamp the pinion shaft 8 situated between them solidly. The securing plate 10, which has held the pinion shaft 8 in its space between the left side jaw 2 and the right side jaw 3 during the clamping procedure, may now be removed, because it no longer has a function in the tightened state of the clamping bolt 14.

FIG. 4 illustrates functional sections of the clamping bolt 14 from FIG. 2 and FIG. 3 in interaction with the pinion shaft 8 in greater detail. In the illustration of FIG. 4, those parts which are not absolutely necessary for better understanding are left out. As may be seen particularly clearly in FIG. 4, the gripper spring element is composed of a first clamping area 22 and a second clamping area 23, which press directly against the ring shoulder 15. A cam area 24 does not press against the ring shoulder 15, but protrudes above the ring shoulder 15. A spring gap 25, which results as an interrupted area of the gripper spring element 18, namely between the first clamping area 22 and the second clamping area 23, may be seen clearly in FIG. 4. A movement arrow 26 indicates in which direction the cam area 24 is shifted when the clamping bolt 14—assuming a right-handed thread on the external threaded section 19—is tightened. It may be seen clearly in this view that the cam area 24 moves toward the pinion shaft 8 and presses it downward when the clamping bolt 14 is tightened.

Furthermore, it is to be noted that the largest dimension 1 of the gripper spring element 18 is less than the diameter D of the right receptacle opening 12.

The following procedure is used to assemble the clamping part 1 according to FIG. 3. Firstly, the intermediate shaft and/or the steering column having the clamping part 1 suspended thereon is provided when a motor vehicle is manufactured. The clamping part 1 is pivoted away from the intermediate shaft around the intermediate shaft pin opening 5. The steering gear is then mounted on the motor vehicle, the pinion shaft 8 coming to rest in the area of the intermediate shaft. The clamping part 1 does not interfere during installation of the steering gear, because it is pivoted away from the alignment between intermediate shaft and pinion shaft 8.

In a following step, the clamping part 1 is pivoted on the pinion shaft 8, as shown in FIG. 1. In this position, the securing plate 10 secures the pinion shaft 8 so that it is held between the left clamping bolt eye 6 and the right clamping bolt eye 7, as shown in FIG. 1.

The clamping bolt 14 from FIG. 2 is then first inserted into the right receptacle opening 12. The gripper spring element 18 may be pushed easily through the right receptacle opening 12 until the right bearing section 17 is received in the right receptacle opening 12. In this state, the external threaded section 19 engages in the left receptacle opening, the clamping bolt 14 may now be screwed into the left clamping bolt eye 6 by rotation. Upon rotation, the cam area 24 of the gripper spring element 18 also rotates until it stands on the surface of the pinion shaft 8. The clamping bolt 14 may then only be rotated further when the gripper spring element 18 simultaneously slips on the ring shoulder 15 against a friction force. The counterforce required for this purpose is provided by the pinion shaft 8, which is in turn thus pressed into the area between the left clamping bolt eye 6 and the right clamping bolt eye 7, so that it stands on the floor plate 4. As soon as the clamping force generated by the clamping bolt 14 between left clamping bolt eye 6 and right clamping bolt eye 7 is so great that the pinion shaft 8 is clamped, a secure connection exists between the clamping bolt 1 and the pinion shaft 8.

Is obvious that the intermediate shaft may be rotated somewhat before beginning the screwing procedure, so that the clamping bolt 14 may be inserted into the clamping part 1. Only a very small rotational movement is required from the assembly of clamping part 1 and pinion shaft 8, and the further advantage results that after the insertion of the clamping bolt 14, the clamping part 1 no longer has to be rotated to cause clamping.

It is also obvious that a kinematic reversal may be achieved by the present invention in such a way that in a first mounting step the clamping part 1 is already fastened to the pinion shaft 8, while it is first connected to the intermediate shaft (not shown in FIG. 1) in a following mounting step. In principle, the procedure explained above is used.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A clamping part for connecting an intermediate shaft to a pinion shaft of a steering gear of a motor vehicle, the clamping part having two side jaws, which are implemented in such way that the pinion shaft is receivable between them with clamping using a clamping bolt, which has an actuating element for an actuating tool on one end and a threaded section on the end opposite to the actuating element, wherein the clamping bolt has a pressure element, having a projecting pressure section, the pressure element being mounted on the clamping bolt so it is movable against friction force.

2. The clamping part according to claim 1, wherein the pressure element is mounted on the clamping bolt so it is rotatable.

3. The clamping part according to claim 1, wherein the pressure element is implemented as a gripper spring element, which is mounted on a ring shoulder of the clamping bolt between a bolt head and the threaded section of the clamping bolt.

4. The clamping part according to claim 3, wherein the gripper spring element has a spring slot on its circumference.

5. (canceled)

6. (canceled)

7. A method for mounting a steering system of a motor vehicle, comprising the following steps:
providing a motor vehicle with an intermediate shaft and with a steering gear having a pinion shaft, the intermediate shaft or the pinion shaft being connected to one end of a clamping part having two side jaws, which are implemented in such way that the pinion shaft is receivable between them with clamping using a clamping bolt, which has an actuating element for an actuating tool on one end and a threaded section on the end opposite to the actuating element, wherein the clamping bolt has a pressure element, having a projecting pressure section, the pressure element being mounted on the clamping bolt so it is movable against friction force;
turning down the clamping part, so the intermediate shaft and the pinion shaft are connected to one another via the clamping part;
rotating the intermediate shaft until the clamping bolt is insertable into the receptacle openings of the side jaws; and
tightening the clamping bolt, the clamping bolt being rotated in such way that the pressure element presses against the intermediate shaft and/or the pinion shaft.

8. The method for mounting a steering system of a motor vehicle according to claim 14, wherein the pressure element is rotated upon tightening of the clamping bolt in such way that the pressure section presses the intermediate shaft and/or the pinion shaft into the area between the side jaws.
